(19) United States
(12) Patent Application Publication
(10) Pub. No.: US 2020/0288752 A1
(43) Pub. Date: Sep. 17, 2020

(54) Ferment collagen drink and the method of preparing the same

(71) Applicant: Meijun Pan, Yongkang City (CN)

(72) Inventor: Meijun Pan, Yongkang City (CN)

(21) Appl. No.: 16/355,794

(22) Filed: Mar. 17, 2019

(51) Int. Cl. A23L 2/02; A23L 2/66

(52) U.S. Cl. CPC A23L 2/02; A23L 2/66; A23V 2002/00; A23V 2250/5422; A23V 2250/2124; A23V 2250/708; A23V 2250/5432; A23V 2250/032; A23V 2250/506; A23V 2250/2482; A23V 2250/28

(57) ABSTRACT

The present invention disclosed a ferment collagen drink and the method of preparing the same, the ferment collagen drink includes the following raw materials: collagen tripeptide, collagen peptide, blueberry juice concentrate, cherry juice concentrate, apple juice concentrate, dark plum juice concentrate, grape juice concentrate, and lemon juice concentrate, fruit and vegetable ferment powder, fructo-oligosaccharide, konjaku flour, ginseng extract, sea buckthorn fruit powder, donkey-hide gelatin, citric acid, guar gum, Aspartame, vitamin C, and water.

### TECHNICAL FIELD

The present invention relates to the technical field of food and beverage and their preparation methods, particularly relates to a ferment collagen drink and the method of preparing the same.

### BACKGROUND

Ferments, referring to nutrients that have been fermented, by means of fermentation, make the natural organic agricultural products, such as vegetables, fruits, and the like, to suffer from the digestion process in advance, so that foods which enter the intestines and stomach could be absorbed directly into the body without necessary to be digested again, thus apart from decreasing the consumption of enzymes in the body, further reducing the burden on the body's organs. Ferment, virtually enzyme, which is a substance consisting of amino acids with specific biological activities, which exists in all living animals and plants, and is a basic substance for various vital activities such as to maintain normal body functions, to digest foods, to repair tissues and the like; which almost participates in all the vital activities and chemical changes in organisms almost all take place under the catalysis of ferments; which drives chemical reactions that wouldn't have happened, and may also accelerate chemical reactions without altering the nature.

Collagen is one of main components of human body tissue structures, the helical protein twisted by three peptide chains is a glycoprotein, which widely exists in human skins, blood vessels, skeletons, physiques, and cartilages, and plays important roles in the formation of the above portions, especially in the joints of human skeletons, the collagen content is higher, thus maintaining the flexible movements of joints.

With the enhancement of people's health awareness, healthy food has gradually gone into people's life, while it remains a blank area on the market about the health care products with ferment and collagen eaten together.

### SUMMARY

The object of the present invention is to provide a drink containing ferment and collagen and the preparation method thereof.

A ferment collagen drink, which includes the raw materials in the following parts by weight: collagen tripeptide 6-10 parts, collagen peptide 1-3 parts, blueberry juice concentrate 5-9 parts, cherry juice concentrate 2-6 parts, apple juice concentrate 2-5 parts, dark plum juice concentrate 1-3 parts, grape juice concentrate 1-2 parts, lemon juice concentrate 0.8-1.2 parts, fruit and vegetable ferment powder 0.08-0.12 parts, fructo-oligosaccharide 0.08-0.12 parts, konjaku flour 0.08-0.12 parts, ginseng extract 0.09-0.098 parts, sea buckthorn fruit powder 0.09-0.098 parts, donkey-hide gelatin 0.08-0.095 parts, citric acid 0.1-0.14 parts, guar gum 0.08-0.12 parts, Aspartame 0.01-0.03 parts, vitamin C 0.08-0.12 parts, and water 65-75 parts.

Further, the ferment collagen drink, which includes the raw materials in the following parts by weight: collagen tripeptide 8 parts, collagen peptide 2 parts, blueberry juice concentrate 6 parts, cherry juice concentrate 4 parts, apple juice concentrate 3 parts, dark plum juice concentrate 2 parts, grape juice concentrate 1 parts, lemon juice concentrate 1 parts, fruit and vegetable ferment powder 0.1 parts, fructo-oligosaccharide 0.1 parts, konjaku flour 0.1 parts, ginseng extract 0.095 parts, sea buckthorn fruit powder 0.095 parts, donkey-hide gelatin 0.09 parts, citric acid 0.12 parts, guar gum 0.1 parts, Aspartame 0.02 parts, vitamin C 0.1 parts, and water 70 parts.

A preparation method of the ferment collagen drink, which includes the following steps:

(1) preparing blueberry juice concentrate, cherry juice concentrate, apple juice concentrate, dark plum juice concentrate, grape juice concentrate, and lemon juice concentrate, ready for use;

(2) mixing each raw material and stirring evenly, filtering, and sterilizing to give the ferment collagen drink.

Further, in step (2), the temperature at which each raw material was mixed and stirred was 60-90° C.; the filtration was: the mixed materials was filtered over a screen of 120-300 meshes to remove the insoluble substances. The temperature of mixing and stirring was set at 60-90° C., which helps the raw materials dissolve in water and the temperature was not too high to damage the effective ingredients in the raw materials.

Further, in step (2), the filtered mixtures were packed, and then sterilized.

Further, in step (2), the sterilization was performed at the temperature of 120-130° C., for a period of 15-20 min.

Further, in step (1), the preparation method of blueberry juice concentrate, cherry juice concentrate, apple juice concentrate, dark plum juice concentrate, grape juice concentrate, and lemon juice concentrate, which includes the following steps:

a, picking blueberry, cherry, apple, dark plum, grape, and lemon, and washing respectively;

b, squeezing blueberry, cherry, apple, dark plum, grape, and lemon, respectively, to give blueberry juice, cherry juice, apple juice, dark plum juice, grape juice, and lemon juice;

c, the juices obtained in step b were pasteurized respectively;

d, into the pasteurized juices were added amylase and pectinase to perform enzymolysis;

e, after the enzymolysis, the juices were filtered, concentrated, and sterilized to give blueberry juice concentrate, cherry juice concentrate, apple juice concentrate, dark plum juice concentrate, grape juice concentrate, and lemon juice concentrate.

Further, in step c, the temperature of the pasteurization was 70-80° C., for a period of 50-60s, with controlling the cooling temperature at 35-40° C.

Further, in step d, the additive amount of amylase was 0.03-0.06 g/L; the additive amount of pectinase was 0.1-0.15 g/L.

Further, in step e: the sterilization was performed at the temperature of 95-105° C., for a period of 90-100s.

Collagen tripeptide is the minimum structural unit of collagen prepared with pigskin and fishskin as the raw materials by an advanced bioengineering technology, which is a tripeptide containing glycine, proline or hydroxyproline plus an additional amino acid. Simply, Collagen tripeptide actually is a small molecular structure intercepted from large collagen molecules by an advanced bioengineering technology, which is useful for the skin. As the molecular weight of collagen tripeptide is small, it could be fully absorbed by human body, meanwhile, collagen tripeptide also may permeate into the stratum corneum, the dermis layer, and hair root cells effectively, which has the effects of moisturizing, nourishing, brightening and anti-wrinkling, has the effects of anti-aging, calcium supplement, regulating female endocrine disorder, and promoting ulcer healing.

Collagen peptide could permeate into the stratum corneum and the dermis layer effectively, achieving various effects such as prolonging the life span of skin cells, inhibiting peroxidation of cell membrane lipids, resisting the attack of oxidative free radicals on DNA, inhibiting the activity of tyrosine, increasing the immunity ability of the skin, improving the water retention ability of the skin, promoting the synthesis of collagen and the synthesis of dermal cell hyaluronic acid.

Blueberry juice concentrate contains abundant nutrient contents, and has the functions of preventing the cerebral nerve aging, protecting the eyesight, strengthening the heart, anti-cancer, softening the blood vessel, and enhancing human immunity. Anthocyanins contained in blueberry may promoter the regeneration of rhodopsin in retinal cells, thus preventing shortsightedness and enhancing the eyesight; anthocyanins in blueberry have strong anti-oxidation and anti-free radicals, which may delay aging, prevent the degeneration of cells, with some effects on inhibiting platelet aggregation and preventing disorders such as brain lesions and arteriosclerosis.

Cherry juice concentrate may be good for the spleen and stomach, may nourish the liver and the kidney, astringe essence, relieve diarrhea, may supplement the demand of iron element in the body, promote the regeneration of hemoglobin, which may prevent iron deficiency anemia, but also may improve physical fitness and promote intelligence growth.

Apple juice concentrate contains abundant carbohydrates, vitamins and microelements, sugars, organic acids, pectin, proteins, calcium, phosphorus, potassium, iron, vitamin A, vitamin B, vitamin C and dietary fibers, further contains malic acid, tartaric acid, carotene, which is one with the highest nutritive value in all vegetables and fruits.

Dark plum juice concentrate contains malic acid, vitamins B, sterols, citric acid, iron, vitamin E, vitamin C, phosphorus and the like, with the effect of strengthening the spleen and stomach. It also contains sitosterol, vitamin C, citric acid; which has the functions of preventing foods from corruption in intestines and stomach, and disinfection, may help to remove toxins in the blood, with the effects of increasing energy and eliminating fatigue.

Grape juice concentrate contains minerals such as calcium, potassium, phosphorus, iron, and a variety of vitamin B1, vitamin B2, vitamin B6, vitamin C and vitamin P and the like, also contains many amino acids necessary for human. Eating grapes regularly is of great advantages for neurasthenia and overfatigue.

Lemon juice concentrate is rich in vitamin C, sugars, calcium, phosphorus, iron, vitamin B1, vitamin B2, nicotinic acid, quininic acid, citric acid, malic acid, hesperidin, naringin, coumarin, high-amount potassium element and low-amount sodium element and the like, which are all beneficial to human bodies.

Fruit and vegetable ferment powder is the ferment powder refined from fruits and vegetables such as pineapple, pawpaw, blueberry, psyllium husk and the like by particular high technologies such as ultrafiltration concentration and freeze drying, which has the effects of improving gastrointestinal functions, maintaining beauty and keeping young, activating cells, lowering tri-high, and anti-aging.

Fructo-oligosaccharide is a new sweetener which has the healthcare functions of adjusting intestinal flora, proliferating bifidobacteria, promoting the absorption of calcium, and regulating blood lipids.

Konjaku flour contains 16 amino acids, 10 minerals, abundant dietary fibers, and various vitamins, which is one of representative foods with low calorie, low fat and high fiber.

Ginseng extract has the effects of reinforcing vital energy, restoring the pulse and relieving depletion, invigorating spleen for benefiting lung, promoting the secretion of saliva and quenching thirst and soothing nerve and promoting intelligence. The ginseng saponin in ginseng has the effect of anti-tumor.

Sea buckthorn fruit powder has good effects of removing lead and antioxidation, without any toxic side effects, which can be used for the nutrient function enhancement of microelements, vitamins, amino acids, and natural pectin.

The primary nutrient of donkey-hide gelatin is protein, with the effects of stopping bleeding and nourishing the blood, improving sleeping, maintaining beauty and keeping young, and anticancer.

Citric acid is mainly used as acidulant, solubilizer, buffering agent, antioxidant, deodorant, flavor enhancer, and coloring agent. Citric acid also has effects of inhibiting the bacteria, protecting the color, enhancing the flavor, and promoting sucrose conversion. Citric acid also has a chelation effect, being capable of removing some harmful metals. Citric acid may prevent oxidations caused by enzyme catalysis and metal catalysis, thus preventing quick-frozen fresh fruits from discoloring and flavor reversion.

Guar gum is a water soluble polymer, which is a macromolecular natural hydrophilic colloid, and a natural thickener.

Aspartame, with high sweetness and low calorie, is mainly added into beverages, vitamin tablets or chewing gum, instead of sugars.

Vitamin C is necessary for maintaining immune functions, keeping blood vessels intact, and promoting the absorption of non-heme iron, meanwhile vitamin C further has anti-oxidation and anti-free radicals, inhibiting the formation of tyrosinase, thus achieving the effects of whitening and spot-fading.

The present invention has the following benefits: the ferment collagen drink described in the present invention takes a variety of fruits and vegetables and protein peptides as raw materials, forming small molecule nutrients and various active ingredients, with the effects of adjusting people's health, improving physiological functions, enhancing physical strength and helping defecation; drinking the ferment collagen drink described in the present invention may provide abundant nutrient contents for the body, promote intestinal peristalsis, discharge carcinogenic substances, improve the functions of intestinal flora, avoid constipation, prevent large intestine diverticular disease and colorectal cancer, reduce the production of neutral fat, help to break down proteins, starches and fat, decrease cholesterol in the serum, with the effect of preventing tri-high; moreover, drinking the ferment collagen drink described in the present invention regularly has the effects of depleting acne, whitening, removing free radicals in skin and delaying skin aging.

### DESCRIPTION OF THE EMBODIMENTS

### Embodiment 1

A ferment collagen drink, which includes the raw materials in the following parts by weight: collagen tripeptide 6 kg, collagen peptide 1 kg, blueberry juice concentrate 5 kg, cherry juice concentrate 2 kg, apple juice concentrate 2 kg, dark plum juice concentrate 1 kg, grape juice concentrate 1 kg, lemon juice concentrate 0.8 kg, fruit and vegetable ferment powder 0.08 kg, fructo-oligosaccharide 0.08 kg, konjaku flour 0.08 kg, ginseng extract 0.09 kg, sea buckthorn fruit powder 0.09 kg, donkey-hide gelatin 0.08 kg, citric acid 0.1 kg, guar gum 0.08 kg, Aspartame 0.01 kg, vitamin C 0.08 kg, and water 65-kg.

A preparation method of the ferment collagen drink, which includes the following steps:

(1) preparing blueberry juice concentrate, cherry juice concentrate, apple juice concentrate, dark plum juice concentrate, grape juice concentrate, and lemon juice concentrate, ready for use;

(2) mixing each raw material and stirring evenly, filtering, and sterilizing to give the ferment collagen drink.

### Embodiment 2

A ferment collagen drink, which includes the raw materials in the following parts by weight: collagen tripeptide 8 kg, collagen peptide 2 kg, blueberry juice concentrate 6 kg, cherry juice concentrate 4 kg, apple juice concentrate 3 kg, dark plum juice concentrate 2 kg, grape juice concentrate 1 kg, lemon juice concentrate 1 kg, fruit and vegetable ferment powder 0.1 kg, fructo-oligosaccharide 0.1 kg, konjaku flour 0.1 kg, ginseng extract 0.095 kg, sea buckthorn fruit powder 0.095 kg, donkey-hide gelatin 0.09 kg, citric acid 0.12 kg, guar gum 0.1 kg, Aspartame 0.02 kg, vitamin C 0.1 kg, and water 70 kg.

A preparation method of the ferment collagen drink, which includes the following steps:

(1) preparing blueberry juice concentrate, cherry juice concentrate, apple juice concentrate, dark plum juice concentrate, grape juice concentrate, and lemon juice concentrate, ready for use;

(2) each raw material was mixed and stirred evenly at the temperature of 60° C., then the mixed materials were filtered over a screen of 120 meshes to remove the insoluble substances, which were then packed. The packed product was sterilized at the temperature of 120° C. for 15 min to give the ferment collagen drink.

### Embodiment 3

A ferment collagen drink, which includes the raw materials in the following parts by weight: collagen tripeptide 7 kg, collagen peptide 1 kg, blueberry juice concentrate 6 kg, cherry juice concentrate 3 kg, apple juice concentrate 3 kg, dark plum juice concentrate 2 kg, grape juice concentrate 1 kg, lemon juice concentrate 0.8 kg, fruit and vegetable ferment powder 0.1 kg, fructo-oligosaccharide 0.1 kg, konjaku flour 0.08 kg, ginseng extract 0.09 kg, sea buckthorn fruit powder 0.09 kg, donkey-hide gelatin 0.08 kg, citric acid 0.1 kg, guar gum 0.08 kg, Aspartame 0.02 kg, vitamin C 0.09 kg, and water 72 kg.

A preparation method of the ferment collagen drink, which includes the following steps:

(1) picking blueberry, cherry, apple, dark plum, grape, and lemon, which were washed respectively, squeezing the blueberry, cherry, apple, dark plum, grape, and lemon after washing, to give blueberry juice, cherry juice, apple juice, dark plum juice, grape juice, and lemon juice; the resulting juices were sterilized at the temperature of 70° C. for 50s respectively, and pasteurized while controlling the cooling temperature at 35° C.; into the sterilized juices were added amylase and pectinase to perform enzymolysis, the additive amount of amylase was 0.03 g/L, the additive amount of pectinase was 0.1 g/L; after the enzymolysis, the juices were filtered and concentrated, and then sterilized at the temperature of 95° C. for 90s, to give blueberry juice concentrate, cherry juice concentrate, apple juice concentrate, dark plum juice concentrate, grape juice concentrate, and lemon juice concentrate;

(2) each raw material was mixed and stirred evenly at the temperature of 60° C., then the mixed materials were filtered over a screen of 150 meshes to remove the insoluble substances, which were then packed. The packed product was sterilized at the temperature of 122° C. for 18 min to give the ferment collagen drink.

### Embodiment 4

A ferment collagen drink, which includes the raw materials in the following parts by weight: collagen tripeptide 10 kg, collagen peptide 3 kg, blueberry juice concentrate 9 kg, cherry juice concentrate 6 kg, apple juice concentrate 5 kg, dark plum juice concentrate 3 kg, grape juice concentrate 2 kg, lemon juice concentrate 1.2 kg, fruit and vegetable ferment powder 0.12 kg, fructo-oligosaccharide 0.12 kg, konjaku flour 0.12 kg, ginseng extract 0.098 kg, sea buckthorn fruit powder 0.098 kg, donkey-hide gelatin 0.095 kg, citric acid 0.14 kg, guar gum 0.12 kg, Aspartame 0.03 kg, vitamin C 0.12 kg, and water 75 kg.

A preparation method of the ferment collagen drink, which includes the following steps:

(1) picking blueberry, cherry, apple, dark plum, grape, and lemon, which were washed respectively, squeezing the blueberry, cherry, apple, dark plum, grape, and lemon after washing, to give blueberry juice, cherry juice, apple juice, dark plum juice, grape juice, and lemon juice; the resulting juices were sterilized at the temperature of 80° C. for 60s respectively, and pasteurized while controlling the cooling temperature at 40° C.; into the sterilized juices were added amylase and pectinase to perform enzymolysis, the additive amount of amylase was 0.06 g/L, the additive amount of pectinase was 0.15 g/L; after the enzymolysis, the juices were filtered and concentrated, and then sterilized at the temperature of 105° C. for 100s, to give blueberry juice concentrate, cherry juice concentrate, apple juice concentrate, dark plum juice concentrate, grape juice concentrate, and lemon juice concentrate;

(2) each raw material was mixed and stirred evenly at the temperature of 90° C., then the mixed materials were filtered over a screen of 300 meshes to remove the insoluble substances, which were then packed. The packed product was sterilized at the temperature of 130° C. for 20 min to give the ferment collagen drink.

### Embodiment 5

A ferment collagen drink, which includes the raw materials in the following parts by weight: collagen tripeptide 9 kg, collagen peptide 3 kg, blueberry juice concentrate 8 kg, cherry juice concentrate 5 kg, apple juice concentrate 4 kg, dark plum juice concentrate 2 kg, grape juice concentrate 1 kg, lemon juice concentrate 1 kg, fruit and vegetable ferment powder 0.1 kg, fructo-oligosaccharide 0.09 kg, konjaku flour 0.09 kg, ginseng extract 0.096 kg, sea buckthorn fruit powder 0.096 kg, donkey-hide gelatin 0.09 kg, citric acid 0.12 kg, guar gum 0.08 kg, Aspartame 0.02 kg, vitamin C 0.1 kg, and water 72 kg.

A preparation method of the ferment collagen drink, which includes the following steps:

(1) picking blueberry, cherry, apple, dark plum, grape, and lemon, which were washed respectively, squeezing the blueberry, cherry, apple, dark plum, grape, and lemon after washing, to give blueberry juice, cherry juice, apple juice, dark plum juice, grape juice, and lemon juice; the resulting juices were sterilized at the temperature of 75° C. for 58s respectively, and pasteurized while controlling the cooling temperature at 38° C.; into the sterilized juices were added amylase and pectinase to perform enzymolysis, the additive amount of amylase was 0.05 g/L, the additive amount of pectinase was 0.12 g/L; after the enzymolysis, the juices were filtered and concentrated, and then sterilized at the temperature of 100° C. for 95s, to give blueberry juice concentrate, cherry juice concentrate, apple juice concentrate, dark plum juice concentrate, grape juice concentrate, and lemon juice concentrate;

(2) each raw material was mixed and stirred evenly at the temperature of 80° C., then the mixed materials were filtered over a screen of 200 meshes to remove the insoluble substances, which were then packed. The packed product was sterilized at the temperature of 125° C. for 18 min to give the ferment collagen drink.

The present invention is not limited to the above optimal implementation mode, and any other various forms of products can be obtained by any person under the teachings of the present invention, while no matter any changes are made in details, the technical schemes which are the same as or similar to the application are all fall within the protection scope of the present invention.

What is claimed is:

1. A ferment collagen drink, which is characterized in that, including the raw materials in the following parts by weight: collagen tripeptide 6-10 parts, collagen peptide 1-3 parts, blueberry juice concentrate 5-9 parts, cherry juice concentrate 2-6 parts, apple juice concentrate 2-5 parts, dark plum juice concentrate 1-3 parts, grape juice concentrate 1-2 parts, lemon juice concentrate 0.8-1.2 parts, fruit and vegetable ferment powder 0.08-0.12 parts, fructo-oligosaccharide 0.08-0.12 parts, konjaku flour 0.08-0.12 parts, ginseng extract 0.09-0.098 parts, sea buckthorn fruit powder 0.09-0.098 parts, donkey-hide gelatin 0.08-0.095 parts, citric acid 0.1-0.14 parts, guar gum 0.08-0.12 parts, Aspartame 0.01-0.03 parts, vitamin C 0.08-0.12 parts, and water 65-75 parts.

2. The ferment collagen drink according to claim 1, which is characterized in that, including the raw materials in the following parts by weight: collagen tripeptide 8 parts, collagen peptide 2 parts, blueberry juice concentrate 6 parts, cherry juice concentrate 4 parts, apple juice concentrate 3 parts, dark plum juice concentrate 2 parts, grape juice concentrate 1 parts, lemon juice concentrate 1 parts, fruit and vegetable ferment powder 0.1 parts, fructo-oligosaccharide 0.1 parts, konjaku flour 0.1 parts, ginseng extract 0.095 parts, sea buckthorn fruit powder 0.095 parts, donkey-hide gelatin 0.09 parts, citric acid 0.12 parts, guar gum 0.1 parts, Aspartame 0.02 parts, vitamin C 0.1 parts, and water 70 parts.

3. A preparation method of the ferment collagen drink according to claim 1, which is characterized in that, including the following steps:
(1) preparing blueberry juice concentrate, cherry juice concentrate, apple juice concentrate, dark plum juice concentrate, grape juice concentrate, and lemon juice concentrate, ready for use;
(2) each raw material was mixed and stirred evenly, filtered and sterilized to give the ferment collagen drink.

4. The preparation method of the ferment collagen drink according to claim 3, which is characterized in that, in step (2), the temperature at which each raw material was mixed and stirred was 60-90° C.; the filtration was: the mixed materials was filtered over a screen of 120-300 meshes to remove the insoluble substances.

5. The preparation method of the ferment collagen drink according to claim 3, which is characterized in that, in step (2), the filtered mixtures were packed, and then sterilized.

6. The preparation method of the ferment collagen drink according to claim 3, which is characterized in that, in step (2), the sterilization was performed at the temperature of 120-130° C., for a period of 15-20 min.

7. The preparation method of the ferment collagen drink according to claim 3, which is characterized in that, in step (1), the preparation method of blueberry juice concentrate, cherry juice concentrate, apple juice concentrate, dark plum juice concentrate, grape juice concentrate, and lemon juice concentrate, which includes the following steps:
a, picking blueberry, cherry, apple, dark plum, grape, and lemon, and washing respectively;
b, squeezing blueberry, cherry, apple, dark plum, grape, and lemon, respectively, to give blueberry juice, cherry juice, apple juice, dark plum juice, grape juice, and lemon juice;
c, the juices obtained in step b were pasteurized respectively;
d, into the pasteurized juices were added amylase and pectinase to perform enzymolysis;
e, after the enzymolysis, the juices were filtered, concentrated, and sterilized to give blueberry juice concentrate, cherry juice concentrate, apple juice concentrate, dark plum juice concentrate, grape juice concentrate, and lemon juice concentrate.

8. The preparation method of the ferment collagen drink according to claim 7, which is characterized in that, in step c, the temperature of the pasteurization was 70-80° C., for a period of 50-60s, with controlling the cooling temperature at 35-40° C.

9. The preparation method of the ferment collagen drink according to claim 7, which is characterized in that, in step d, the additive amount of amylase was 0.03-0.06 g/L; the additive amount of pectinase was 0.1-0.15 g/L.

10. The preparation method of the ferment collagen drink according to claim 7, which is characterized in that, in step e: the sterilization was performed at the temperature of 95-105° C., for a period of 90-100s.
